(19) United States
(12) Patent Application Publication
(10) Pub. No.: US 2005/0071534 A1
(43) Pub. Date: Mar. 31, 2005

(54) Chassis expansion using newcard

(75) Inventor: Ajay Kwatra, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/675,396

(22) Filed: Sep. 30, 2003

(51) Int. Cl. G06F 13/36

(52) U.S. Cl. 710/315

(57) ABSTRACT

In a method and system for partitioning a computer into a first and second subsystem, a Newcard device is defined to electrically couple the first subsystem to the second subsystem. The first subsystem is defined to include certain selectable components of the computer having at least one common property, while the second subsystem is defined to include remaining components of the computer. The Newcard device includes a first port electrically coupled to the first subsystem by a first connector, a second port electrically coupled to the second subsystem by a second connector, and a communication component electrically coupled to the first and second ports. The second port includes at least one high speed serial communications bus. The communication component is operable to control signals transferred between the first and second connector.

### CROSS-REFERENCE TO RELATED APPLICATION

This application is related to United States patent application having Attorney Docket No. 16356.824, filed Sep. 30, 2003 and entitled “Powered Newcard Connector” by inventor Ajay Kwatra. The entire content of the above-identified application is incorporated herein by reference.

### BACKGROUND

The present disclosure relates generally to information handling systems, and more particularly to techniques for improving expansion capabilities of a computer included in an information handling system.

As the value and use of information continues to increase, individuals and businesses seek additional ways to acquire, process and store information. One option available to users is information handling systems. An information handling system (‘IHS’) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In order to increase the potential capabilities and/or the functionality of computers, it is common practice to add corresponding new hardware to empty slots, if available. In these cases, typically the plug-and-play functionality of the computer automatically detects the new hardware and assists the user in configuring or setting up the new device. A main chassis typically includes the motherboard of the computer. If no empty slots are available, it is common practice to add, extend or split the main chassis to a new expansion chassis having additional expansion slots. Expansion slots allow expansion cards to be inserted into the computer such that the circuitry of the new cards becomes part of the overall computer system. For example, expansion cards may be added for functions such as additional memory, specialized interfaces for communicating with external devices or networks, circuitry for improved multimedia effects, circuitry for removable storage devices, and many other capabilities that can be desirous in various applications. In order to add an expansion card to a system, the card is typically inserted into an expansion slot and then mounted to the original chassis of the computer with a mounting bracket.

In the past few years there has been an increased demand for smaller and lighter form factors in the portable, as well as desktop, computing environments. The smaller form factor often results in a limited number of peripherals and/or spare slots being available to a user for adding new hardware. Thus, the trend towards smaller and lighter form factors often results in the user requiring additional mounting space to accommodate new hardware.

Power consumed by the processors included in the computers is increasing from one technology generation to the next. The power supply voltage required by the processors is decreasing (to approximately 1 V) and thereby causing the current drawn to exceed several amperes. As a result, most computer systems are generating more heat, which causes them to get hotter. Cooling fans, which have become necessary, add to the noise levels. It may be conceivable to create an expansion chassis to accommodate quieter components of the computer and the main chassis to retain the hotter and noisier components.

However, present techniques for creating an expansion chassis to accommodate new hardware are not simple, and cost effective. For example, adding or expanding a desktop computer system requires the user to power down the computer, open the main chassis, add interface cards to the new chassis, and add, connect and secure the expansion chassis to the main chassis. Custom connectors and cables are often required, which add to the cost and make it more difficult to manufacture in large volumes. In addition, these techniques also lack the performance since adding an expansion chassis typically requires the presence of a high bandwidth communication link between the main chassis and the expansion chassis.

Therefore, a need exists to create additional chassis space to accommodate new hardware and/or redistribute existing hardware. More specifically, a need exist to develop tools and techniques for creating mounting space to accommodate existing and/or new hardware with improved simplicity, cost and performance. Accordingly, it would be desirable to provide tools and techniques for improving expansion capabilities of a computer included in an IHS absent the disadvantages found in the prior methods discussed above.

### SUMMARY

The foregoing need is addressed by the teachings of the present disclosure, which relates to a system and method for improving expansion capabilities of a computer. According to one embodiment, in a method and system for partitioning the computer into a first and second subsystem, a Newcard device is defined to electrically couple the first subsystem to the second subsystem. The first subsystem is defined to include certain selectable components of the computer having at least one common property, while the second subsystem is defined to include remaining components of the computer. The Newcard device includes a first port electrically coupled to the first subsystem by a first connector, a second port electrically coupled to the second subsystem by a second connector, and a communication component electrically coupled to the first and second ports. The second port includes at least one high speed serial communications bus. The communication component is operable to control signals transferred between the first and second connector.

In one embodiment, a method for partitioning a computer into a first and second subsystems includes preparing the first subsystem by including certain selectable components of the computer having at least one common property to define the first subsystem, preparing the second subsystem by including the remaining components of the computer to define the second subsystem and electrically coupling the first and second subsystems via at least one Newcard such as the Newcard device.

Several advantages are achieved by the method and system according to the illustrative embodiments presented herein. The embodiments advantageously provide for a system and method for adding, extending or splitting a main chassis to accommodate new hardware and/or redistribute existing hardware, which is independent of form factors, is cost effective being standards based, is easy to use since it does not require the user to open the main chassis, and offers an improved performance.

### BRIEF DESCRIPTION OF THE DRAWINGS

FIG. 1 illustrates a diagrammatic representation of a Newcard device operable to electrically couple first and second subsystems of a computer, according to an embodiment;

FIG. 2 is a flow chart illustrating a method for partitioning a computer into subsystems shown in FIG. 1, according to an embodiment;

FIG. 3 illustrates a diagrammatic representation of a split chassis implementation of a computer using the Newcard device shown in FIG. 1, according to an embodiment; and

FIG. 4 illustrates a block diagram of an information handling system to implement method or apparatus aspects of the present disclosure, according to an embodiment.

### DETAILED DESCRIPTION

The functionality of various devices or components described herein may be implemented as hardware (including firmware and circuits) and/or software, depending on the application requirements.

Many prior art techniques are available to create an expansion chassis for a computer to accommodate new hardware. However, these techniques are not simple, and cost effective. Custom connectors and cables are often required, which add to the cost and make it more difficult to manufacture in large volumes. In addition, these techniques also lack the performance since adding an expansion chassis typically requires the presence of a high bandwidth communication link between the main chassis and the expansion chassis. It would be desirable to improve the creation of additional space to accommodate new hardware and/or redistribute existing hardware. According to one embodiment, in a method and system for partitioning the computer into a first and second subsystem, a Newcard device is defined to electrically couple the first subsystem to the second subsystem. The first subsystem is defined to include certain selectable components of the computer having at least one common property, while the second subsystem is defined to include remaining components of the computer. The Newcard device includes a first port electrically coupled to the first subsystem by a first connector, a second port electrically coupled to the second subsystem by a second connector, and a communication component electrically coupled to the first and second ports. The second port includes at least one high speed serial communications bus. The communication component is operable to control signals transferred between the first and second connector.

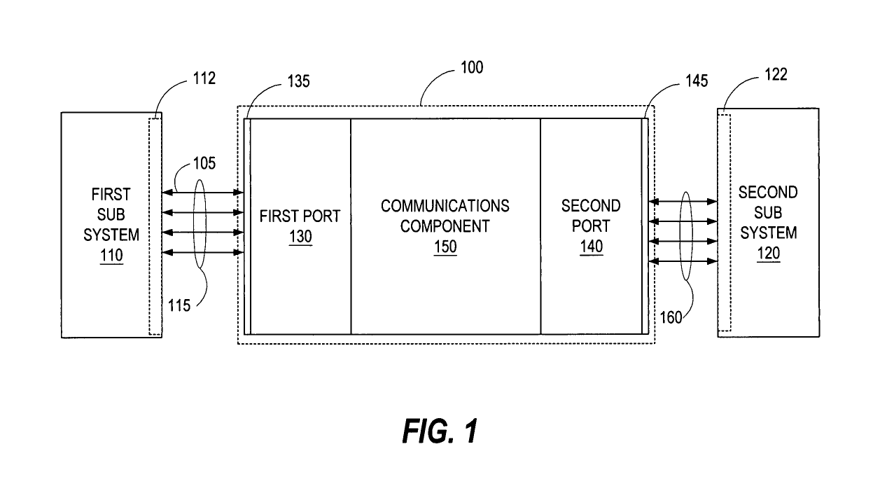

FIG. 1 illustrates a diagrammatic representation of a Newcard device 100 operable to electrically couple a first subsystem 110 and a second subsystem 120 of a computer (not shown), according to an embodiment. In one embodiment, components of the computer are partitioned into the first and second subsystems 110 and 120 based on at least one predefined criteria. For example, components included in the main chassis (not shown) of the computer may be defined to be the first subsystem 110 whereas components included in a new expansion chassis (not shown) may be defined to be the second subsystem 120. Typical components included in the first subsystem 110 may include a controller (not shown) and a processor (not shown). The controller typically receives instructions from the processor enabling the controller to control the operation of the Newcard device 100. The controller may also control the operation of expansion cards (not shown), which may be included in the expansion chassis. As another example, components of the computer, which are hotter and noisier than others, may be used as the predefined criteria to partition the subsystems. Components such as the processor and a blower fan assembly (not shown) may be included in the first subsystem 110, whereas remaining components of the computer may be defined to be included in the second subsystem 120. As yet another example, components of the computer that require proximity to the user such as power switches and removable media storage devices may be defined to be included in the second subsystem 120, whereas the remaining components may be included in the first subsystem 110.

In one embodiment, the Newcard device 100 is based on an emerging Newcard standard being developed by PCMCIA (Personal Computer Memory Card International Association). The PCMCIA is a well known international standards organization and trade association that was founded to establish standards for Integrated Circuit (IC) cards and to promote interchangeability among personal computers (PC's). The new format for the Newcard device 100 is based on existing technologies such as PC Card and Universal Serial Bus (USB) 2.0, as well as emerging technologies such as PCI Express (PCIE). The approximate dimensions for the Newcard device are 1.3 inches wide, 3.0 inches long, and 0.2 inches thick. By comparison, a Type II PC Card is 2.2 by 3.4 by 0.2 inches. The Newcard format is applicable for both portable and desktop computing environments.

The Newcard device 100 includes a first port 130 having a first connector 135, a second port 140 having a second connector 145 and a communications component 150. A connector, in general, includes an electrical device operable to electrically couple or interconnect one device to another. The first and second connectors 135 and 145 are examples of the connector, as described herein. The connector may include traditional male/female coupling type connectors, which are physically as well as electrically coupled. Male/female type connectors are also referred to as plug and socket type connectors and are shaped to only mate together in one way. Some connectors may include directly attached connections such as a soldering type connection to achieve the interconnection. Various other types of connectors such as a spring-loaded connector may also be used.

The first port 130 enables bidirectional communications between the first subsystem 110 of the computer and the Newcard device 100 via multiple links 115. In one embodiment, the first connector 135 is a male-type connector designed to match a corresponding female-type adapter 112 included in the first subsystem 110. In this embodiment, the combination of the first connector 135 and the matching female-type adapter 112 is consistent with the Newcard format.

Similarly, the second port 140 enables bi-directional communications between the second subsystem 120 of the computer and the Newcard device 100. In one embodiment, the second port 140 includes at least one high speed serial communications bus 160. In one embodiment, the second port 140 includes two serial communications busses of which one bus conforms to the PCIE standard and the second bus conforms to the USB 2.0 standard. The typical data transfer rates supported by PCIE and USB are approximately 2.5 gigabits per second and 480 megabits per second respectively.

In one embodiment, to achieve additional throughput between the first and second subsystems 110 and 120, two or more Newcard devices (not shown), each of which are substantially similar to the Newcard device 100, may be connected in parallel. In one embodiment, to achieve a longer distance between the first and second subsystems 110 and 120, the at least one high speed serial communications bus 160 such as the PCIE bus and/or USB bus may be re-driven on the Newcard device 100.

In one embodiment, the second connector 145 is a male-type connector designed to match with a corresponding female-type adapter 122 included in the second subsystem 120. In one embodiment, the second connector 145 may use a direct connect mechanism such as a soldered connection. Other interconnect means may also be possible. In one embodiment, the first and second connectors 135 and 145 use a single row of 28 pins (PC Cards use a double stacked row of 68 pins). At least one of the 28 pins of the second connector 145 is used to transfer signals conforming to the PCIE standard.

In one embodiment, the second connector 145 is custom designed to facilitate connections for the at least one serial communications bus 160, which conforms to the PCIE standard. In this embodiment, the number of pins required for the connection may vary depending on the application requirements. However, at least one of these pins of the second connector 145 is used to transfer signals conforming to the PCIE standard.

In one embodiment, the first connector 135 of the Newcard device 100 is inserted into the corresponding matching female-type adapter 112 included in the first subsystem 110 and the second connector 145 is inserted into the corresponding matching female-type adapter 122 included in the second subsystem 120 to achieve the electrical coupling between the two subsystems 110 and 120 via the Newcard device 100.

The communications component 150, which is electrically coupled to the first and second ports 130 and 140, is operable to control the flow of signals transferred between the first and second connectors 135 and 145. The communications component 150 may include communication components such as buffers, store and forward registers and repeaters to direct the flow of signals. In one embodiment, the controller included in the first subsystem 110 controls the operation of the communications component 150.

In one embodiment, the Newcard device 100 includes communications with a System Management Bus (SMBus) 105. The SMBus 105, which is well known, is used in IHS for low-speed system management communications. In one embodiment, the connection to the SMBus 105 may be included in the first connector 135.

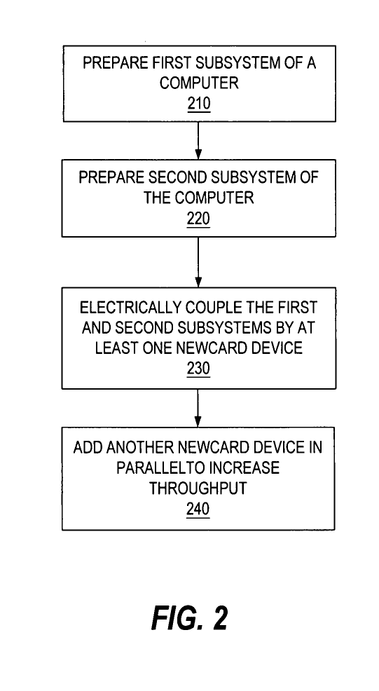

FIG. 2 is a flow chart illustrating a method for partitioning a computer into subsystems shown in FIG. 1, according to an embodiment. In step 210, the first subsystem 110 is prepared by including certain selectable components of the computer having at least one common property to define the first subsystem 110. As described earlier, in one embodiment, a first common property may be an amount heat generated and a second common property may be an amount of noise generated. For example, the first subsystem 110 may include certain selectable components such as the processor, which generates a large amount of heat, and a fan assembly (required for cooling the processor), which generates a lot of noise. In step 220, the second subsystem 120 is prepared by including the remaining components of the computer to define the second subsystem 120. In step 230, the first and second subsystems 110 and 120 are electrically coupled via at least one Newcard such as the Newcard device 100, as described in FIG. 1.

Various steps described above may be added, omitted, combined, altered, or performed in different orders. For example, step 240 may be added so that another Newcard device, which is substantially similar to the Newcard device 100, is coupled in parallel to achieve additional throughput between the first and second subsystems 110 and 120.

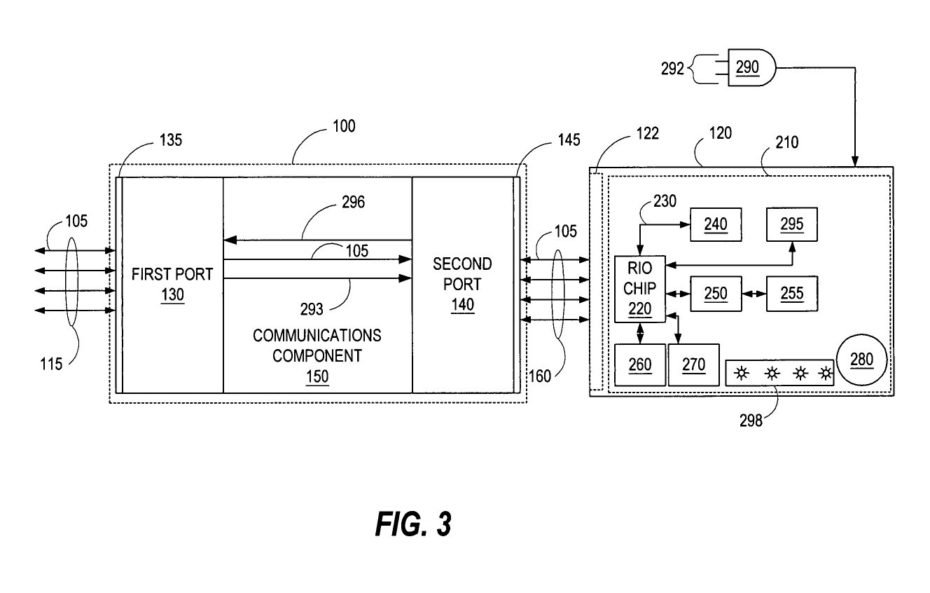

FIG. 3 illustrates a diagrammatic representation of a split chassis implementation of a computer (not shown) using the Newcard device 100, according to an embodiment. In this embodiment, the computer is split into the first and second subsystems 110 and 120 based on factors such as heat and noise generation, and proximity to the user. As described earlier, the first subsystem 110 includes selectable components of the computer, which are hotter and noisier than others. For example, motherboard components such as the processor and main chassis components such as the blower fan assembly may be selected to be included in the first subsystem 110. The second subsystem 120 includes selectable components of the computer which are less hotter and noisier than others, and other components which are operable by the user as inputs and/or outputs. In one embodiment, the second subsystem 120 includes a user console 210, which is operable by the user to control the inputs and/or outputs of the computer.

In one embodiment, the user console 210 includes a remote I/O (RIO) chip 220 that interfaces to the at least one high speed serial communications bus 160 such as the PCIE bus. In one embodiment, the RIO chip 220 interfaces to 2 PCIE buses for improved throughput. The RIO chip 220 includes a parallel and/or serial ATA channel 230, both of which are well known industry standards for interfacing to a removable storage device (RMSD) 240. The RIO chip 220 has an audio codec '97 (AC '97) interface 250 card with corresponding audio connectors 255 for a complete audio implementation. AC '97 is a well known standard which defines a high-quality, 20-bit audio architecture for the computer and is widely used in today's desktop platforms. As an option, the RIO chip 220 may connect to additional I/O devices such as legacy I/O 260, other I/O 270 such as bar code scanner (not shown) and/or a 6-in-1 memory card reader (not shown). The SMBus 105 is extended to the user console 210 by the Newcard device 100. As an option, the RIO chip 220 may connect to USB ports 295 to interface to USB devices.

In one embodiment, a power button on/off switch 280 is included in the user console 210. The power button on/off switch 280 is conveniently located and easily accessible to the user to control the power provided to the user console 210 and/or the computer. A status signal 296 for the power button on/off switch 280 is provided to the first subsystem 110 via the Newcard device 100. Feedback is provided to the user by various means such as via light emitting diodes (LED's) 298 to indicate the operational status of the power, and various peripherals. Additional LED's may be included to show diagnostic information.

In one embodiment, an optional power adapter module 290 provides power to the second subsystem 120 including the user console 210. The optional power adapter module 290 is operable to receive an AC power input 292 and convert it to various voltages as required by the user console 210. In one embodiment, the second subsystem 120 including the user console 210 derives power from the main chassis via a power line 293 of the Newcard device 100.

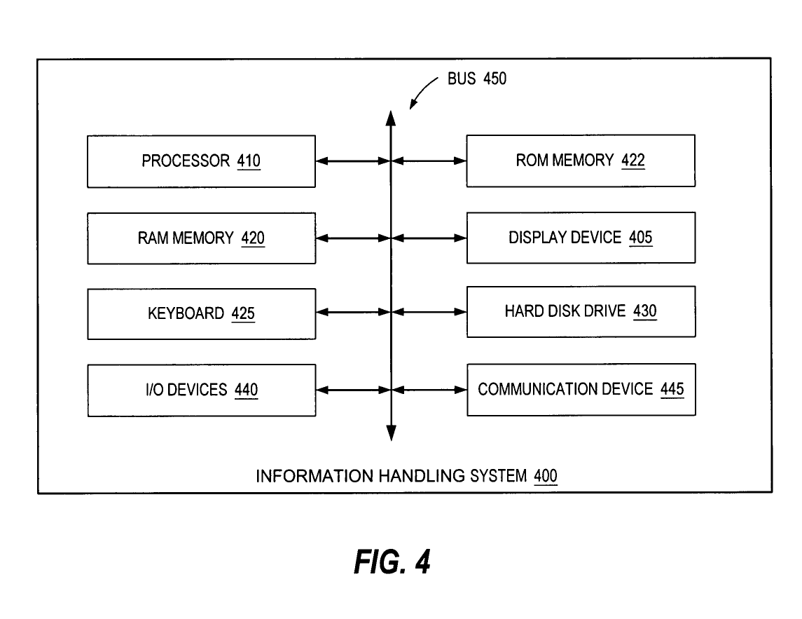

FIG. 4 illustrates a block diagram of an information handling system to implement method or apparatus aspects of the present disclosure, according to an embodiment. For purposes of this disclosure, an information handling system 400 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the information handling system 400 may be a personal computer, including notebook computers, personal digital assistants, cellular phones and gaming consoles, a network storage device, or any other suitable device and may vary in size, shape, performance, functionality, and price.

The information handling system 400 may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring to FIG. 4, the information handling system 400 includes a processor 410, a system random access memory (RAM) 420, a system ROM 422, a display device 405, a keyboard 425 and various other input/output devices 440. It should be understood that the term “information handling system” is intended to encompass any device having a processor that executes instructions from a memory medium. The IHS 400 is shown to include a hard disk drive 430 connected to the processor 410 although some embodiments may not include the hard disk drive 430. The processor 410 communicates with the system components via a bus 450, which includes data, address and control lines. A communications device 445, may be connected to the bus 450 to enable information exchange between the system 400 and other devices. In one embodiment, the bus 450 is extended into another chassis by using the Newcard device 100.

In one embodiment, the information handling system 400 may be used to implement the computer described in FIG. 1. The processor 410 is operable to execute the computing instructions and/or operations of the information handling system 400. The memory medium, e.g., RAM 420, preferably stores instructions (also known as a “software program”) for implementing various embodiments of a method in accordance with the present disclosure. In various embodiments the one or more software programs, are implemented in various ways, including procedure-based techniques, component-based techniques, and/or object-oriented techniques, among others. Specific examples include assembler, C, XML, C++ objects, Java and Microsoft Foundation Classes (MFC).

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A Newcard device to electrically couple a first and second subsystem of a computer, the computer being partitioned into the first and second subsystems based on at least one predefined criteria, the Newcard device comprising:
a first port electrically coupled to the first subsystem by a first connector;
a second port electrically coupled to the second subsystem by a second connector, wherein the second port includes at least one high speed serial communications bus; and
a communication component electrically coupled to the first and second ports, wherein the communication component is operable to control signals transferred between the first and second connectors.

2. The device of claim 1, wherein the at least one high speed serial communications bus conforms to PCIE standard.

3. The device of claim 1, wherein the second port includes a second serial communications bus conforming to USB standard.

4. The device of claim 1, wherein the first connector includes 28 pins.

5. The device of claim 4, wherein at least one of the 28 pins is used to transfer signals conforming to PCIE standard.

6. The device of claim 1, wherein the first and second subsystems are coupled by two Newcard devices connected in parallel, wherein the two Newcard devices are substantially identical.

7. The device of claim 1, wherein the second subsystem is defined to include components operable to interact with a user.

8. The device of claim 1, wherein a first predefined criteria is heat generation and a second predefined criteria is noise generation.

9. The device of claim 8, wherein the first subsystem is placed at a sufficient distance away from a user to substantially reduce effects of the heat generation and the noise generation.

10. The device of claim 8, wherein the first subsystem includes a processor and a fan assembly included in the computer, wherein an operation of the processor and the fan assembly causes the heat generation and the noise generation.

11. A method for partitioning a computer into subsystems, the method comprising:
preparing a first subsystem, wherein the first subsystem is defined to include certain selectable components of the computer having at least one common property;
preparing a second subsystem, wherein the second subsystem is defined to include remaining components of the computer; and
electrically coupling the first and second subsystems by at least one Newcard device, wherein the at least one Newcard device includes:
a first port electrically coupled to the first subsystem by a first connector;
a second port electrically coupled to the second subsystem by a second connector, wherein the second port includes at least one high speed serial communications bus; and
a communication component electrically coupled to the first and second ports, wherein the communication component is operable to control signals transferred between the first and second connector.

12. The method of claim 11, wherein the at least one high speed serial communications bus conforms to PCIE standard.

13. The method of claim 11, wherein the second port includes a second serial communications bus conforming to USB standard.

14. The method of claim 11, wherein the first connector includes 28 pins.

15. The method of claim 14, wherein at least one of the 28 pins is used to transfer signals conforming to PCIE standard.

16. The method of claim 11, wherein the first and second subsystems are coupled by two Newcards connected in parallel, wherein the two Newcards are substantially identical.

17. The method of claim 11, wherein the second subsystem is defined to include components operable to interact with a user.

18. The method of claim 11, wherein a first common property is heat generation and a second common property is noise generation.

19. The method of claim 18, wherein the first subsystem is placed at a sufficient distance away from a user to substantially reduce effects of the heat generation and the noise generation.

20. The method of claim 18, wherein the certain selectable components include a processor and a fan assembly, wherein an operation of the processor and the fan assembly causes the heat generation and the noise generation.

21. An information handling system comprising:
a first subsystem including a processor, and a memory coupled to the processor;
a second subsystem including at least one expansion card; and
a Newcard device electrically coupled to the first and second subsystems, wherein the Newcard device includes:
a first port electrically coupled to the first subsystem by a first connector;
a second port electrically coupled to the second subsystem by a second connector, wherein the second port includes at least one high speed serial communications bus; and
a communication component electrically coupled to the first and second ports, wherein the communication component is directed by the processor to control signal transfer between the first and second connectors.

22. The system of claim 21, wherein the at least one expansion card is operable to receive data from the processor via the at least one high speed serial communications bus.
